(19) United States
(12) Patent Application Publication
(10) Pub. No.: US 2014/0074323 A1
(43) Pub. Date: Mar. 13, 2014

(54) METHOD FOR MODIFYING AN AIRCRAFT FLIGHT PLAN ON A TOUCH-SENSITIVE SCREEN

(71) Applicant: Thales, Neuilly Sur Seine (FR)

(72) Inventors: Cecile ANDRE, Bordeaux (FR); Francois Michel, St. Medard En Jalles (FR); Yannick Le Roux, St. Medard En Jalles (FR); Bruno Aymeric, St Medard En Jalles (FR)

(21) Appl. No.: 14/020,731

(22) Filed: Sep. 6, 2013

(30) Foreign Application Priority Data
Sep. 7, 2012 (FR) 1202392

(51) Int. Cl. G06F 3/0481

(52) U.S. Cl. CPC G06F 3/04815
USPC 701/3

(57) ABSTRACT

The general area of the invention is that of methods for managing flight plans by an avionic system comprising a visualization device and a touch-sensitive interface. The visualization device displays a cartographic representation of the terrain flown over, aeronautical data and a flight plan composed of a set of segments connecting together certain aeronautical waypoints. The management method contains several steps, a first editing step activated by touch-sensitive designating of any point of the flight plan, a second modification of the flight plan step activated by a touch-sensitive movement, the end of the touch-sensitive movement triggering a movement or an addition or the removal of a waypoint. The method also makes it possible to easily manage the airways in order to incorporate them into a flight plan during modification.

The general area of the invention is that of the presentation, control and modification of information concerning the flight plan and the navigation of an aircraft. In current aircraft, visualization devices present the flight plan followed by the aircraft. It is generally displayed in a form superimposed on a cartographic representation of the terrain flown over. During flight, modifications to this flight plan are liable to occur. The method according to the invention concerns a simple and ergonomic method for modifying the flight plan.

In most aircraft cockpits, the flight plan output by the Flight Management System or FMS can be modified by means of a text list of waypoints. In latest-generation cockpits such as those of the Airbus A380 or of the Falcon 7X from the company Dassault, flight plan modifications can also be carried out graphically on a dedicated screen called the Navigation Display using a graphic pointer. In both cases, the flight plan revisions are made by way of a contextual menu. The main modifications are essentially the removal or addition of one or more waypoints. The modified flight plan then appears as a temporary flight plan once the action has been performed. The modified flight plan then appears on the Navigation Display screen. The user thus sees the effect of the modifications in progress and can choose to activate or cancel the modified flight plan so that it may or may not become the active flight plan.

However, these modification methods have a number of drawbacks. Certain functions, such as the movement of a first waypoint onto a second waypoint, or the creation of a set of waypoints showing an airway section, are hard to carry out simply and in a single operation. Secondly, the pilot does not immediately see the result of the modification he has just made, requiring a confirmation phase after modification.

The method according to the invention does not exhibit these drawbacks. It requires a display screen comprising a touch-sensitive interface. The method makes it possible to benefit from the advantages of the touch-sensitive interface while meeting the specific requirements of the task of modifying a flight plan in a cockpit. The advantages of the touch-sensitive interface are considerable. Thus, the user uses his finger to directly handle the objects in the flight plan that are the waypoints or the legs connecting the waypoints together. The action is simplified by the absence of intermediate instruments such as graphic pointers or menus. The user sees the result of his action while he is carrying out the action and not once the action has been performed. The risk of error is thus minimized. Moreover, this new method perfectly meets the specific requirements of the task of modifying a flight plan in a cockpit. It makes it possible to cater for the lack of precision of touch-sensitive interactions in cockpits when the user moves, removes or inserts a waypoint. The method according to the invention also takes into account the peculiarities of aeronautical flight plans. In fact, flight plans are not always defined by a simple series of waypoints, but are also defined by portions of airways. In addition to the movement, the removal and the insertion of waypoints, the proposed system thus allows the user to graphically insert sections of airways.

More precisely, the subject of the invention is a method for the management of a flight plan of an aircraft in flight by an avionic system comprising at least one visualization device and a touch-sensitive interface dedicated to this visualization device and implemented by means of touch-sensitive contacts, said visualization device displaying a cartographic representation of the terrain flown over by the aircraft, aeronautical data containing aeronautical waypoints and a flight plan composed of a set of segments connecting together some of said aeronautical waypoints,

characterized in that the management method contains at least two steps, a first “editing” step activated by touch-sensitive designating of any point of a segment or of a waypoint of the flight plan and a second “modification of the flight plan” step activated by a touch-sensitive movement starting on any point or on a first waypoint of the flight plan and ending in the vicinity of a second aeronautical waypoint, the end of the touch-sensitive movement triggering a movement of the first aeronautical waypoint towards a second waypoint or an addition of the second waypoint or the removal of the first waypoint.

Advantageously, when the modification of the flight plan is a movement or an addition of an aeronautical waypoint to the flight plan, the visualization device displays the airways passing through the “modified” aeronautical waypoint.

Advantageously, the method contains a third “insertion” step activated by touch-sensitive designating of an airway and triggering the display of all or some of the aeronautical waypoints of said designated airway.

Advantageously, the method contains a fourth “selection” step activated by touch-sensitive designating of a waypoint known as the aeronautical exit point of said designated airway and triggering the incorporation into the flight plan of the set of aeronautical waypoints situated between the modified waypoint and the exit waypoint.

Advantageously, when the touch-sensitive movement is at a predefined distance from a selectable aeronautical waypoint, an area of interest centred on said selectable aeronautical waypoint is displayed and in that, if the touch-sensitive movement comes to an end in said area of interest, the selectable aeronautical waypoint is selected.

Advantageously, the editing step prompts the visualization device to show a menu containing four selection buttons, a first button for validation of the latest modification to the flight plan, a second button for cancellation of the latest modification to the flight plan, a third button enabling display of the previous modifications going backwards in time and a fourth button enabling display of the previous modifications going forwards in time.

The invention will be better understood and other advantages will become apparent upon reading the description below, which is in no way limiting and is provided with reference to the appended figures, in which:

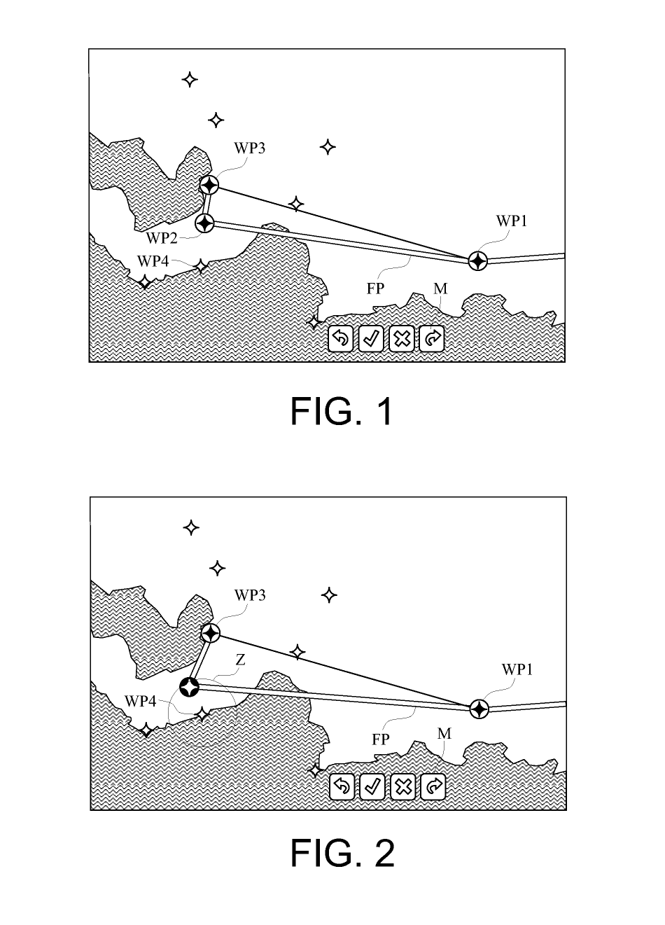

FIGS. 1, 2 and 3 show the steps of the method for managing the flight plan according to the invention when the modification to the flight plan corresponds to movement of an aeronautical waypoint;

FIGS. 4, 5 and 6 show the steps of the method for managing the flight plan according to the invention when the modification to the flight plan corresponds to the removal of an aeronautical waypoint;

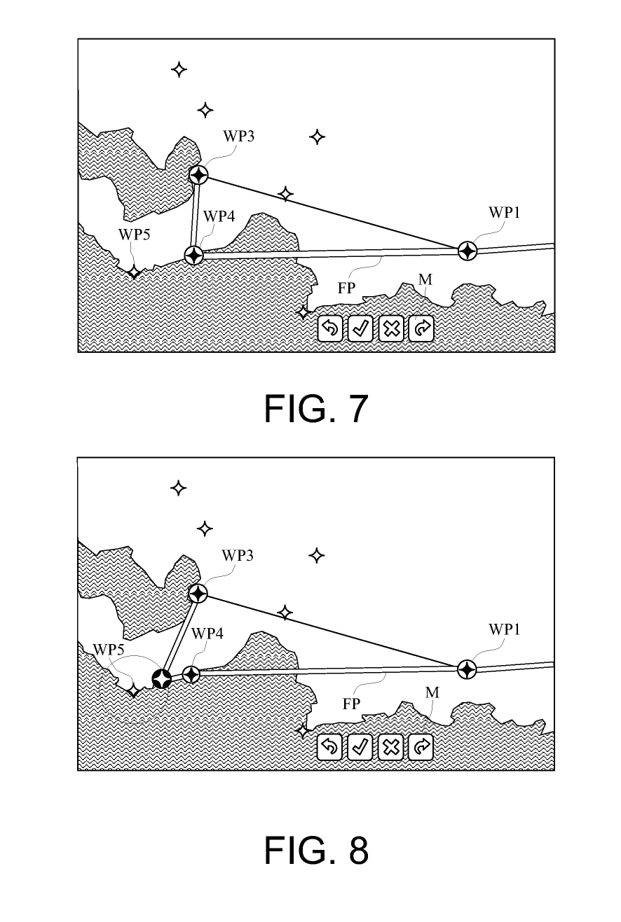

FIGS. 7, 8 and 9 show the steps of the method for managing the flight plan according to the invention when the modification to the flight plan corresponds to the addition of an aeronautical waypoint;

FIGS. 10, 11 and 12 show the steps of the method for managing the flight plan according to the invention in the case of the selection of a section of airway comprising at least one waypoint;

FIGS. 12, 13 and 14 show the steps of the method for managing the flight plan according to the invention in the case of the selection of a section of airway comprising several waypoints.

The method for managing a flight plan of an aircraft in flight according to the invention is implemented in a modern avionic system. The latter comprises at least one cockpit visualization device containing a touch-sensitive interface and an electronic and IT environment making it possible to display on the screen of the visualization device a cartographic representation of the terrain flown over by the aircraft, containing the various graphic elements of a flight plan, and to take into account the controls output by the touch-sensitive interface. These systems exist on all modern aircraft. Different technical principles exist that enable the provision of a touch-sensitive interface. By way of example, the touch-sensitive interface may be of resistive or capacitive type or may implement optical transmitting and receiving components. The touch-sensitive interface has the advantage of enabling intuitive and fast implementation of the method without adding additional graphical control interfaces.

By way of non-limiting example, FIGS. 1 to 15 illustrate the various steps of the method according to the invention. These figures show part of a visualization screen. This screen contains a touch-sensitive surface that is not shown in the various figures for reasons of clarity. These figures in wire-frame representation comply with the requirements for patent figures. In the various figures, only the coastline of the terrain is shown. In reality, the overflown terrain is shown in colour according to the traditional conventions specific to cartographic representation. The various symbol sets are shown in colour and/or in semi-transparency in such a way as to obtain the best possible ergonomics.

In these various figures, the following conventions have been adopted. The various waypoints are shown by lozenges with concave sides. They are black or white, circled or not circled, according to whether or not they belong to a flight plan, according to whether or not they are selected; the flight plan is composed of white segments connecting various waypoints; the directions of the airways are shown by arrows. The four symbols of the menu selection buttons are shown using traditional conventions. The first validation button is shown by a check mark in the shape of a V, the second cancellation button by an X-shaped cross, the third button by an arrow turning to the left and the fourth button by an arrow turning to the right. The four buttons are aligned on one and the same horizontal line on the figures. It is of course possible to use other conventions and other graphical arrangements while remaining within the scope of this invention.

To make a modification to the flight plan using the method according to the invention, two successive steps are followed. In a first step, by means of a long tap on any object in the graphical flight plan, the user enters an Editing mode in which he can directly handle the objects in the flight plan. The long tap makes it possible to avoid accidental flight plan modifications. There again, other conventions are possible. The Editing mode is indicated to the user by a modification to the graphic for the flight plan and the display of a menu for the activation or the cancellation of the modifications performed.

In a second “modification” step, when the user has performed a long tap on an object in the flight plan in order to enter Editing mode, he may either keep his finger pressed on this object to directly perform a modification on this object, or release his finger and perform a modification on any other object in the flight plan. To move a waypoint, the user points to this waypoint with his finger, slides it and releases it onto the new desired position, either onto an existing waypoint or anywhere on the map, in which case a “user waypoint” will be created. The moved waypoint is then replaced by the new waypoint. When the slid waypoint is close to a selectable waypoint, an area of interest appears around the latter. The radius of the area of interest is chosen as a function of the scale of the displayed terrain. The user can then release his finger and the waypoint associated with the area of interest is selected. This area of interest makes it possible to absorb any lack of precision in the touch-sensitive interactions in a cockpit.

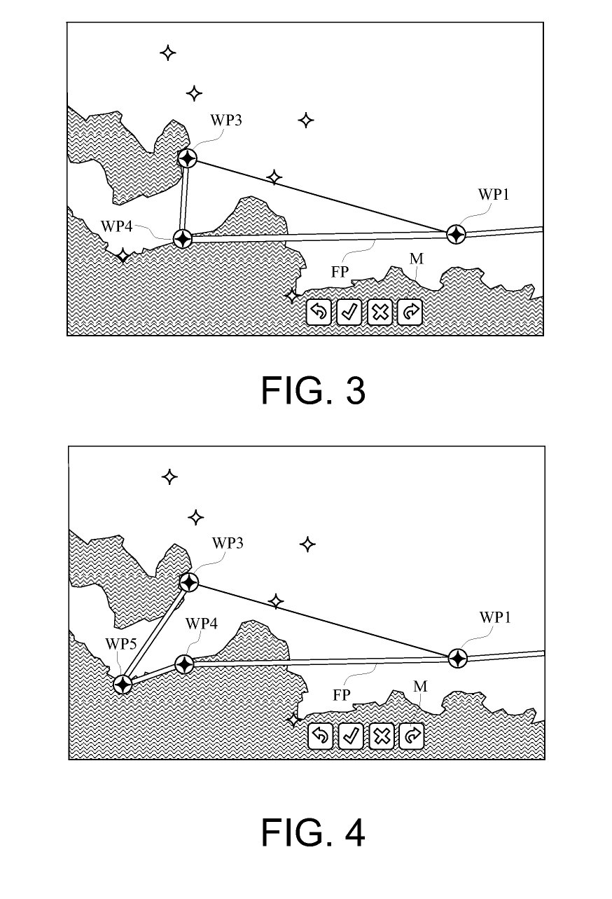

FIGS. 1, 2 and 3 show the steps of the method for managing the flight plan according to the invention when the modification of the flight plan corresponds to a movement of an aeronautical waypoint. Initially, as illustrated in FIG. 1, the flight plan FP passes through the points WP1, WP2 and WP3. The user wishes to modify the location of the waypoint WP2 to position it on the waypoint WP4. The user points to the waypoint WP2 and slides it towards WP4 as illustrated in FIG. 2. An area of interest Z depicted by a hairline circle appears around the waypoint WP4 when the moved waypoint is nearby. During the movement of the waypoint, the user sees the new flight plan develop, and directly perceives the effect of the modification. The user releases his finger from the area of interest of WP4 and the waypoint WP2 is then replaced by WP4 as illustrated in FIG. 3. The menu M makes it possible to validate, remove or modify this choice.

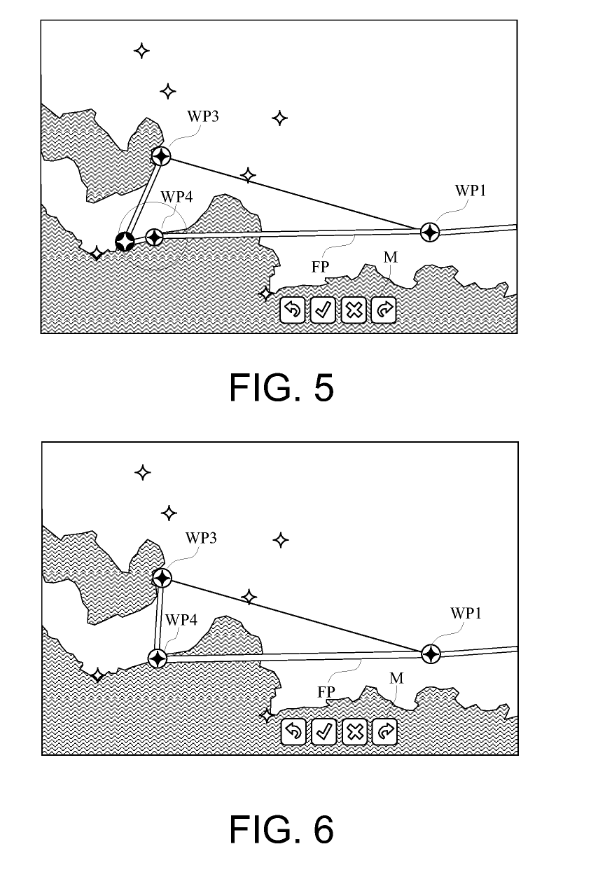

FIGS. 4, 5 and 6 show the steps of the method for managing the flight plan according to the invention when the modification of the flight plan corresponds to the removal of an aeronautical waypoint. Initially, as illustrated in FIG. 4, the flight plan FP passes through the points WP1, WP4, WP5 and WP3. The user wishes to remove the waypoint WP5. He points to the waypoint WP5 and slides it towards WP4 as illustrated in FIG. 5. An area of interest Z depicted by a circle appears around the waypoint WP4 when the moved waypoint is nearby. During the movement of the waypoint, the user sees the new flight plan develop and directly perceives the effect of the modification. The user releases his finger from the area of interest of WP4 and the waypoint WP5 is removed as illustrated in FIG. 6. Of course, the removal could have concerned the waypoint WP3. The menu M makes it possible to validate, remove or modify this choice.

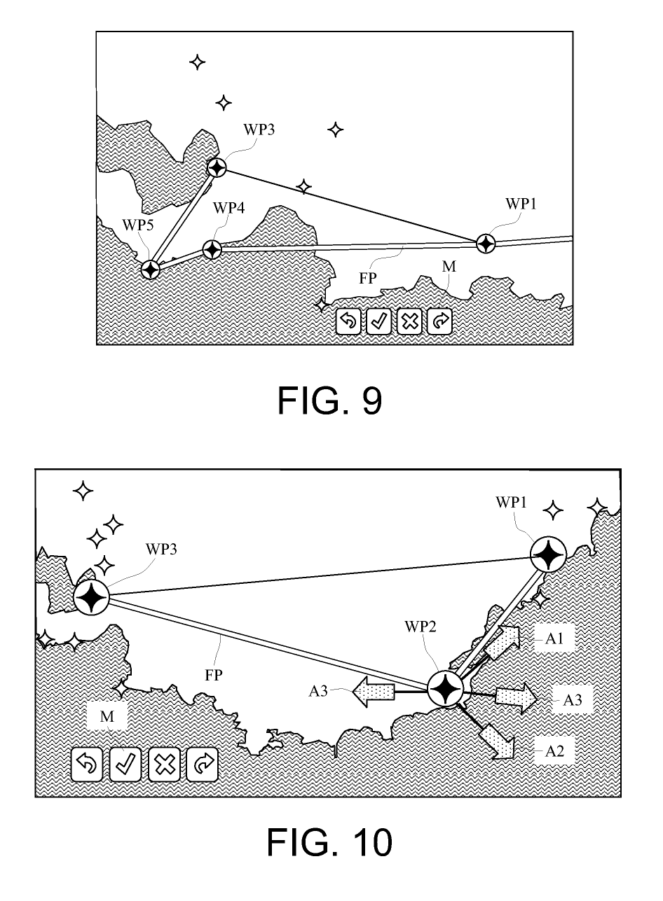

FIGS. 7, 8 and 9 show the steps of the method for managing the flight plan according to the invention when the modification of the flight plan corresponds to the insertion of an aeronautical waypoint. Initially, as illustrated in FIG. 7, the flight plan FP passes through the points WP1, WP4 and WP3. The user wishes to insert the waypoint WP5 between the points WP4 and WP3. The user points to the part of the flight plan joining the waypoints WP3 and WP4, also known as a leg, and slides it towards WP5 as illustrated in FIG. 8. An area of interest Z depicted by a circle appears around the waypoint WP5 when the moved leg is nearby. During the movement of the leg, the user sees the new flight plan develop. The user releases his finger from the area of interest of WP5 and the waypoint WP5 is inserted as illustrated in FIG. 9. The menu M makes it possible to validate, remove or modify this choice.

The method according to the invention also applies to the management of airways. When a new waypoint is selected after a movement or an insertion, the airways passing through this waypoint are displayed with their direction. The user can then select one of these routes directly using his finger. The route is then displayed with the details of its waypoints and the user can thus choose the exit waypoint for this route.

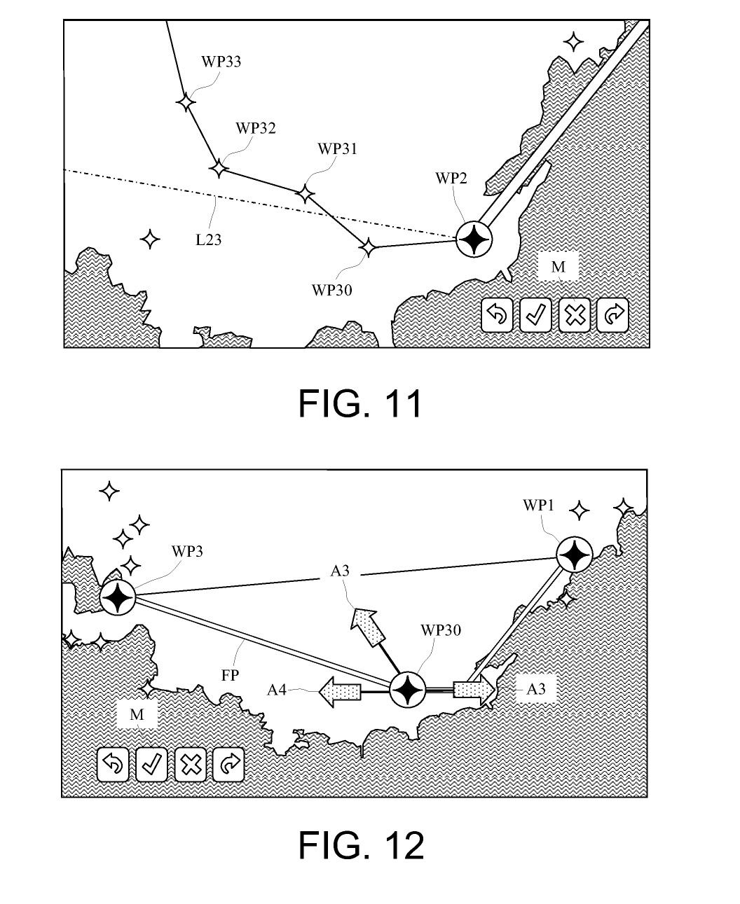

By way of example, FIGS. 10 to 14 show the steps of the method for managing the flight plan according to the invention in the case of the selection of a first airway, then of a second airway. In this example, as seen in FIG. 10, the waypoint W2 has just been inserted in the flight plan FP between WP1 and WP3. The airways A1, A2 and A3 passing through the waypoint W2 are displayed with their respective direction. The user selects the airway A3 and, as seen in FIG. 11, a broken line L23 is then displayed between the waypoints WP2 and WP3. The point WP3 is not shown in FIG. 11. The airway A3 is then presented on departure from W2 with the details of its waypoints WP30, WP31, WP32 and WP33. The user selects WP30. The section of the airway A3 between WP2 and WP30 is then inserted into the flight plan and the discontinuity is removed as seen in FIG. 12. The airways A3 and A4 passing through WP30 are presented to the user.

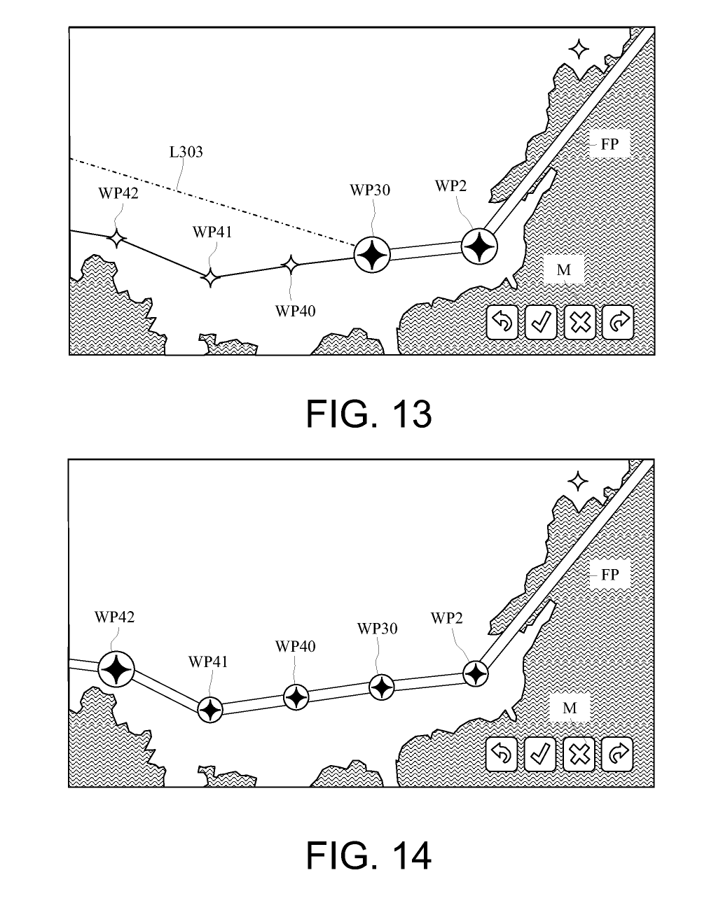

In FIG. 13, the user selects the airway A4 from the waypoint WP30. A broken line L303 is then displayed between WP30 and WP3. The airway A4 is presented on departure from WP30 with the details of its waypoints WP40, WP41 and WP42. The user then selects the waypoint WP42 as exit point. As seen in FIG. 14, the section of the airway A4 between WP30 and WP42 is then inserted into the flight plan with the intermediate waypoints WP40 and WP41, thereby avoiding the need to select all the intermediate waypoints of the airway A4.

The advantages of the method for the management of a flight plan according to the invention are as follows:
Direct interaction of the user with the objects in the flight plan, without intermediate instruments;
Immediate visualization of the effect of the modification in progress at the same time as the user is performing this modification. The user is “in the loop” at all times and the checking is carried out at the same time as the modification.
Consideration of the lack of precision in the touch-sensitive surface by means of the area of interest around the waypoints;
Possible insertion of parts of airways containing several waypoints, graphically, by direct interaction.

1. Method for the management of a flight plan of an aircraft in flight by an avionic system comprising at least one visualization device and a touch-sensitive interface dedicated to this visualization device and implemented by means of touch-sensitive contacts, said visualization device displaying a cartographic representation of the terrain flown over by the aircraft, aeronautical data containing aeronautical waypoints and a flight plan composed of a set of segments connecting together some of said aeronautical waypoints,
wherein the management method contains at least two operations, a first “editing” operation activated by touch-sensitive designating of any point of a segment or of a waypoint of the flight plan and a second “modification of the flight plan” operation activated by a touch-sensitive movement starting on any point or on a first waypoint of the flight plan and ending in the vicinity of a second aeronautical waypoint, the end of the touch-sensitive movement triggering a movement of the first aeronautical waypoint towards a second waypoint or an addition of the second waypoint or the removal of the first waypoint, and in that, when the modification of the flight plan is a movement or an addition of an aeronautical waypoint to the flight plan, the visualization device displays the airways passing through the “modified” aeronautical waypoint.

2. Method for managing a flight plan according to claim 1, wherein the method contains a third “insertion” operation activated by touch-sensitive designating of an airway and triggering the display of all or some of the aeronautical waypoints of said designated airway.

3. Method for managing a flight plan according to claim 2, wherein the method contains a fourth “selection” operation activated by touch-sensitive designating of a third aeronautical waypoint known as the exit point of said designated airway and triggering the incorporation into the flight plan of the set of aeronautical waypoints situated between the modified waypoint and the point known as the exit point.

4. Method for managing a flight plan according to claim 1, wherein, when the touch-sensitive movement is at a predefined distance from a selectable aeronautical waypoint, an area of interest centered on said selectable aeronautical waypoint is displayed and in that, if the touch-sensitive movement comes to an end in said area of interest, the selectable aeronautical waypoint is selected.

5. Method for managing a flight plan according to claim 1, wherein the editing operation prompts the visualization device to show a menu containing four selection buttons, a first button for validation of the latest modification to the flight plan, a second button for cancellation of the latest modification to the flight plan, a third button enabling display of the previous modifications going backwards in time and a fourth button enabling display of the previous modifications going forwards in time.
